(19) United States
(12) Patent Application Publication
(10) Pub. No.: US 2009/0022649 A1
(43) Pub. Date: Jan. 22, 2009

(54) Method for producing ultra-thin nano-scaled graphene platelets

(76) Inventors: Aruna Zhamu, Centerville, OH (US); Jinjun Shi, Columbus, OH (US); Joan Jang, Centerville, OH (US); Bor Z. Jang, Centerville, OH (US)

Correspondence Address: Bor Z. Jang, 9436 Parkside Drive, Centerville, OH, 45458, US

(21) Appl. No.: 11/879,680

(22) Filed: Jul. 19, 2007

(51) Int. Cl. C01B 31/04

(52) U.S. Cl. 423/415.1; 423/448

(57) ABSTRACT

A method of producing ultra-thin, separated nano-scaled platelets having an average thickness no greater than 2 nm or comprising, on average, no more than 5 layers per platelet from a layered graphite material. The method comprises: (a) providing a supply of nano-scaled platelets with an average thickness of no more than 10 nm or having, on average, no more than 30 layers per platelet; and (b) intercalating the supply of nano-scaled platelets to produce intercalated nano platelets and exfoliating the intercalated nano platelets at a temperature and a pressure for a sufficient period of time to produce the ultra-thin nano-scaled platelets. The nano-scaled platelets are candidate reinforcement fillers for polymer nanocomposites. Nano-scaled graphene platelets are much lower-cost alternatives to carbon nano-tubes or carbon nano-fibers.

This invention is based on the research result of a US Department of Energy (DoE) Small Business Innovation Research (SBIR) project. The US government has certain rights on this invention.

### FIELD OF THE INVENTION

The present invention relates to a method of exfoliating and separating graphite, graphite oxide, and other laminar compounds to produce nano-scaled platelets, particularly nano-scaled graphene platelets (NGPs) with an average thickness of no more than 2 nm or 5 layers (5 graphene sheets).

### BACKGROUND

Carbon is known to have four unique crystalline structures, including diamond, graphite, fullerene and carbon nano-tubes. The carbon nano-tube (CNT) refers to a tubular structure grown with a single wall or multi-wall, which can be conceptually obtained by rolling up a graphene sheet or several graphene sheets to form a concentric hollow structure. A graphene sheet is composed of carbon atoms occupying a two-dimensional hexagonal lattice. Carbon nano-tubes have a diameter on the order of a few nanometers to a few hundred nanometers. Carbon nano-tubes can function as either a conductor or a semiconductor, depending on the rolled shape and the diameter of the tubes. Its longitudinal, hollow structure imparts unique mechanical, electrical and chemical properties to the material. Carbon nano-tubes are believed to have great potential for use in field emission devices, hydrogen fuel storage, rechargeable battery electrodes, and as composite reinforcements.

However, CNTs are extremely expensive due to the low yield and low production rates commonly associated with all of the current CNT preparation processes. The high material costs have significantly hindered the widespread application of CNTs. Rather than trying to discover much lower-cost processes for nano-tubes, we have worked diligently to develop alternative nano-scaled carbon materials that exhibit comparable properties, but can be produced in larger quantities and at much lower costs. This development work has led to the discovery of processes for producing individual nano-scaled graphite planes (individual graphene sheets) and stacks of multiple nano-scaled graphene sheets, which are collectively called nano-scaled graphene plates (NGPs). NGPs could provide unique opportunities for solid state scientists to study the structures and properties of nano carbon materials. The structures of these materials may be best visualized by making a longitudinal scission on the single-wall or multi-wall of a nano-tube along its tube axis direction and then flattening up the resulting sheet or plate. Studies on the structure-property relationship in isolated NGPs could provide insight into the properties of a fullerene structure or nano-tube. Furthermore, these nano materials could potentially become cost-effective substitutes for carbon nano-tubes or other types of nano-rods for various scientific and engineering applications. The electronic, thermal and mechanical properties of NGP materials are expected to be comparable to those of carbon nano-tubes; but NGP will be available at much lower costs and in larger quantities.

Direct synthesis of the NGP material had not been possible, although the material had been conceptually conceived and theoretically predicted to be capable of exhibiting many novel and useful properties. Jang and Huang have provided an indirect synthesis approach for preparing NGPs and related materials [B. Z. Jang and W. C. Huang, “Nano-scaled Graphene Plates,” U.S. Pat. No. 7,071,258 (Jul. 4, 2006)]. In most of the prior art methods for making separated graphene platelets, the process begins with intercalating lamellar graphite flake particles with an expandable intercalation agent (also known as an intercalant or intercalate), followed by thermally expanding the intercalant to exfoliate the flake particles. In some methods, the exfoliated graphite is then subjected to air milling, ball milling, or ultrasonication for further flake separation and size reduction. Conventional intercalation and exfoliation methods and recent attempts to produce exfoliated products or separated platelets are given in the following representative references:
1. J. W. Kraus, et al., “Preparation of Vermiculite Paper,” U.S. Pat. No. 3,434,917 (Mar. 25, 1969).
2. L. C. Olsen, et al., “Process for Expanding Pyrolytic Graphite,” U.S. Pat. No. 3,885,007 (May 20, 1975).
3. A. Hirschvogel, et al., “Method for the Production of Graphite-Hydrogensulfate,” U.S. Pat. No. 4,091,083 (May 23, 1978).
4. T. Kondo, et al., “Process for Producing Flexible Graphite Product,” U.S. Pat. No. 4,244,934 (Jan. 13, 1981).
5. R. A. Greinke, et al., “Intercalation of Graphite,” U.S. Pat. No. 4,895,713 (Jan. 23, 1990).
6. F. Kang, “Method of Manufacturing Flexible Graphite,” U.S. Pat. No. 5,503,717 (Apr. 2, 1996).
7. F. Kang, “Formic Acid-Graphite Intercalation Compound,” U.S. Pat. No. 5,698,088 (Dec. 16, 1997).
8. P. L. Zaleski, et al. “Method for Expanding Lamellar Forms of Graphite and Resultant Product,” U.S. Pat. No. 6,287,694 (Sep. 11, 2001).
9. J. J. Mack, et al., “Chemical Manufacture of Nanostructured Materials,” U.S. Pat. No. 6,872,330 (Mar. 29, 2005).
10. L. M. Viculis and J. J. Mack, et al., “Intercalation and Exfoliation Routes to Graphite Nanoplatelet,” J. Mater. Chem., 15 (2005) pp. 974-978.

However, these previously invented methods had a serious drawback. Typically, exfoliation of the intercalated graphite occurred at a temperature in the range of 800° C. to 1,050° C. At such a high temperature, graphite could undergo severe oxidation, resulting in the formation of graphite oxide, which has much lower electrical and thermal conductivities compared with un-oxidized graphite. In our recent studies, we have surprisingly observed that the differences in electrical conductivity between oxidized and non-oxidized graphite could be as high as several orders of magnitude. It may be noted that the approach proposed by Mack, et al. [e.g., Refs. 9 and 10] is also a low temperature process. However, Mack's process involves intercalating graphite with potassium melt, which must be carefully conducted in a vacuum or extremely dry glove box environment since pure alkali metals, such as potassium and sodium, are extremely sensitive to moisture and pose an explosion danger. This process is not amenable to mass production of nano-scaled platelets.

To address these issues, we have recently developed several processes for producing nano-scaled platelets, as summarized in several co-pending patent applications [Refs. 11-14]:
11. Bor Z. Jang, Aruna Zhamu, and Jiusheng Guo, “Process for Producing Nano-scaled Platelets and Nanocomposites,” US Pat. Pending, Ser. No. 11/509,424 (Aug. 25, 2006).
12. Bor Z. Jang, Aruna Zhamu, and Jiusheng Guo, “Mass Production of Nano-scaled Platelets and Products,” US Pat. Pending, Ser. No. 11/526,489 (Sep. 26, 2006).
13. Bor Z. Jang, Aruna Zhamu, and Jiusheng Guo, “Method of Producing Nano-scaled Graphene and Inorganic Platelets and Their Nanocomposites,” US Pat. Pending, Ser. No. 11/709,274 (Feb. 22, 2007).
14. Aruna Zhamu, JinJun Shi, Jiusheng Guo, and Bor Z. Jang, “Low-Temperature Method of Producing Nano-scaled Graphene Platelets and Their Nanocomposites,” US Pat. Pending, Ser. No. 11/787,442 (Apr. 17, 2007).
15. Aruna Zhamu, Jinjun Shi, Jiusheng Guo and Bor Z. Jang, “Method of Producing Exfoliated Graphite, Flexible Graphite, and Nano-Scaled Graphene Plates,” US Pat. Pending, Ser. No. 11/800,728 (May 8, 2007).

References [11,12] are related to processes that entail a pressurized gas-induced intercalation procedure to obtain a tentatively intercalated layered compound and a heating and/or gas releasing procedure to generate a supersaturation condition for inducing exfoliation of the layered compound. Tentative intercalation implies that the intercalating gas molecules are forced by a high gas pressure to reside tentatively in the interlayer spaces. Once the intercalated material is exposed to a thermal shock, these gas molecules induce a high gas pressure that serves to push apart neighboring layers. Reference [13] is related to a halogen intercalation procedure, followed by a relatively low-temperature exfoliation procedure. No strong acid like sulfuric acid or nitric acid is used in this process (hence, no SO₂ or NO₂ emission) and halogen can be recycled and re-used. This is an environmentally benign process.

Reference [14] provides a low-temperature method of exfoliating a layered material to produce separated nano-scaled platelets. The method entails exposing a graphite intercalation compound to an exfoliation temperature lower than 650° C. for a duration of time sufficient to at least partially exfoliate the layered graphite without incurring a significant level of oxidation. This is followed by subjecting the partially exfoliated graphite to a mechanical shearing treatment to produce separated platelets. The key feature of this method is the exfoliation at low temperature to avoid oxidation of graphite. This was based on the finding that no oxidation of graphite occurs at 650° C. or lower for a short duration of heat exposure (e.g., shorter than 45 seconds) and at 350° C. or lower for a slightly longer duration of heat exposure (e.g., 2 minutes). The resulting NGPs exhibit very high electrical conductivity, much higher than that of NGPs obtained with exfoliation at higher temperatures.

In all of aforementioned prior art methods and our co-pending applications, the process begins with intercalation of graphite, followed by gas pressure-induced exfoliation of the resulting intercalated graphite. The gas pressure is generated by heating and/or chemical reaction. However, intercalation by a chemical (e.g., an acid) may not be desirable. Exfoliation by heat can put graphite at risk of oxidation. After exfoliation, an additional mechanical shear treatment is needed to separate the exfoliated graphite into isolated platelets. In essence, every one of these processes involves three separate steps, which can be tedious and energy-intensive. Hence, another one of our earlier inventions provided a convenient method of exfoliating a laminar material to produce nano-scaled platelets (mostly thinner than 10 nm) without the intercalation step and, hence, without the utilization of an intercalant such as sulfuric acid [Ref. 15]. This method comprises (a) dispersing graphite or graphite oxide particles in a liquid medium containing therein a surfactant or dispersing agent to obtain a suspension or slurry; and (b) exposing the suspension or slurry to ultrasonic waves (a process commonly referred to as ultrasonication) at an energy level for a sufficient length of time to directly produce the separated nano-scaled platelets. This is an energy-efficient, environmentally benign, and fast way of producing nano-scaled platelets.

Although prior art intercalation-exfoliation methods might be able to sporadically produce a small amount of ultra-thin graphene platelets (e.g., 1-5 layers), most of the platelets produced are much thicker than 5 layers or 2 nm. Many of the NGP applications require the NGPs to be as thin as possible; e.g., as a supercapacitor electrode material. Hence, it is desirable to have a method that is capable of consistently producing ultra-thin NGPs.

It is an object of the present invention to provide a method of expanding a laminar (layered) compound or element, such as graphite and graphite oxide (partially oxidized graphite), to produce ultra-thin graphite and graphite oxide flakes or platelets, with an average thickness smaller than 2 nm or thinner than 5 layers.

It is a particular object of the present invention to provide a simple, fast, and less energy-intensive method of producing ultra-thin graphite and graphite oxide platelets (e.g., on an average, no more than 5 layers per platelet).

It is another object of the present invention to provide a convenient method of exfoliating a laminar material to produce ultra-thin, nano-scaled platelets without the intercalation step and, hence, without the utilization of an intercalant such as sulfuric acid.

It is yet another object of the present invention to provide a convenient method of exfoliating a laminar material to produce ultra-thin, nano-scaled platelets without involving a heat- or chemical reaction-induced gas pressurization step.

Another object of the present invention is to provide an effective and consistent method of mass-producing ultra-thin, nano-scaled platelets.

It is still another object of the present invention to provide a method of producing ultra-thin, nano-scaled platelets that can be readily dispersed in a liquid to form a nanocomposite structure.

### SUMMARY OF THE INVENTION

The present invention provides a method of producing ultra-thin, separated nano-scaled platelets having an average thickness no greater than 2 nm or comprising, on an average, no more than 5 layers per platelet from a layered graphite material. In one preferred embodiment, the method comprises: (a) providing a supply of nano-scaled platelets with an average thickness of no more than 10 nm or, on an average, having no more than 30 layers per platelet (hereinafter referred to as nano-scaled platelets of intermediate sizes); and (b) intercalating the supply of nano-scaled platelets to produce intercalated nano platelets and exfoliating the intercalated nano platelets at a temperature and a pressure for a sufficient period of time to produce the ultra-thin nano-scaled platelets.

In Step (a), the supply of nano-scaled platelets of intermediate sizes may be obtained through intercalation and exfoliation of the layered graphite material selected from natural graphite, synthetic graphite, highly oriented pyrolytic graphite, graphite fiber, graphitic nano-fiber, graphite oxide, graphite fluoride, chemically modified graphite, or a combination thereof. In a further preferred embodiment, the intercalation and exfoliation of the layered graphite material (producing exfoliated graphite flakes) is followed by a flake separation treatment using air milling, ball milling, mechanical shearing, ultrasonication, or a combination thereof. The step of intercalating typically comprises using an intercalate selected from an acid, an oxidizing agent, a mixture of an acid and an oxidizing agent, a halogen molecule or inter-halogen compound, a metal-halogen compound, an alkali metal, a mixture or eutectic of two alkali metals, an alkali metal-organic solvent mixture, or a combination thereof.

In a preferred embodiment, Step (a) of supplying NGPs of desired intermediate sizes entails intercalating and exfoliating a layered graphite material to produce graphite flakes or nano-scaled platelets with an average thickness of no more than 10 nm or, on an average, having no more than 30 layers. These starting NGPs of intermediate sizes, when re-intercalated and exfoliated in Step (b), become ultra-thin NGPs with an average thickness as small as 2 nm. Although, in many cases, NGPs of larger sizes can be further intercalated and exfoliated to produce ultra-thin NGPs, starting NGPs of excessively larger sizes could lead to the production of thin NGPs with an average thickness greater than 2 nm.

Alternatively, the supply of nano-scaled platelets is obtained through direct ultrasonication of the layered graphite material, dispersed in a liquid medium typically with the assistance of a surfactant or dispersion agent. Preferably, the ultrasonication step is conducted at a temperature lower than 100° C. The energy level is typically greater than 80 watts. Optionally, the ultrasonication step may be followed by a mechanical shearing treatment selected from air milling, ball milling, rotating-blade shearing, or a combination thereof to further separate the platelets and/or reduce the size of the platelets. The liquid medium may comprise water, organic solvent, alcohol, a monomer, an oligomer, or a resin.

In a preferred embodiment of the present invention, Step (b) comprises intercalating nano-scaled platelets of intermediate sizes to obtain re-intercalated graphite flakes. The step of intercalating again can comprise using an intercalate selected from an acid, an oxidizing agent, a mixture of an acid and an oxidizing agent, a halogen molecule or inter-halogen compound, a metal-halogen compound, an alkali metal, a mixture or eutectic of two alkali metals, an alkali metal-organic solvent mixture, or a combination thereof. The re-intercalated compound is then exfoliated to produce ultra-thin NGPs with an average thickness of 2 nm or smaller.

In another preferred embodiment, the nano-scaled platelets of intermediate sizes (prepared by either the intercalation/exfoliation route or the direct ultrasonication route), may be subjected to direct ultrasonication, typically at a higher energy level or amplitude than that would be used to produce the platelets of intermediate thicknesses. This process obviates the need to undergo intercalation and it directly induces exfoliation and separation of graphite flakes or multi-layer platelets. Certain nano-scaled platelets (e.g., graphite oxides) are hydrophilic in nature and, therefore, can be readily dispersed in selected polar solvents (e.g., water). Hence, this invented method intrinsically involves dispersing the platelets in a liquid to form a suspension or in a monomer- or polymer-containing solvent to form a nanocomposite precursor suspension. This suspension can be converted to a mat or paper (e.g., by following a paper-making process). The nanocomposite precursor suspension may be converted to a nanocomposite solid by removing the solvent or polymerizing the monomer. In the case of graphite oxide platelets, the method may further include a step of partially or totally reducing the graphite oxide (after the formation of the suspension) to become graphite (serving to recover at least partially the high conductivity that a pristine graphite would have).

It may be noted that ultrasonication has been used to successfully separate graphite flakes after exfoliation. Examples are given in Sakawaki, et al. (“Foliated Fine Graphite Particles and Method for Preparing Same,” U.S. Pat. No. 5,330,680, Jul. 19, 1994); Chen, et al. (“Preparation and Characterization of Graphite Nanosheets from Ultrasonic Powdering Technique,” Carbon, Vol. 42, 2004, 753-759); and Mack, et al. (U.S. Pat. No. 6,872,330, Mar. 29, 2005). However, there had been no report on the utilization of ultrasonic waves in directly exfoliating graphite or graphite oxide (with or without intercalation) and, concurrently, separating exfoliated particles into isolated or separated graphite flakes or platelets with a thickness less than 100 nm. Those who are skilled in the art of expandable graphite, graphite exfoliation, and flexible graphite have hitherto believed that graphite or other laminar material must be intercalated first to obtain a stable intercalation compound prior to exfoliation. They have further believed that the exfoliation of graphite intercalation compounds necessarily involve high temperatures. It is extremely surprising for us to observe that prior intercalation is not required of graphite for exfoliation and that exfoliation can be achieved by using ultrasonic waves at relatively low temperatures (e.g., room temperature), with or without prior intercalation.

It may be further noted that Viculis, et al [Ref. 10] did report that “graphite nanoplatelets with thickness down to 2-10 nm are synthesized by alkali metal intercalation followed by ethanol exfoliation and microwave drying.” This was achieved by intercalating graphite with an oxidizing acid to form a graphite intercalation compound (GIC), exfoliating the GIC, re-intercalating the exfoliated graphite with an alkali metal to form a first-stage (Stage-1) compound, reacting the first-stage compound with ethanol to exfoliate the compound, and further separating the exfoliated graphite with microwave heating. (In traditional GICs obtained by intercalation of a laminar graphite material, the intercalant species may form a complete or partial layer in an inter-layer space or gallery. If there always exists one graphene layer between two intercalant layers, the resulting graphite is referred to as a Stage-1 GIC. If n graphene layers exist between two intercalant layers, we have a Stage-n GIC.) That alkali metals react violently with water and alcohol implies that Visculis's method can not be a safe and reliable process for mass-producing NGPs. Furthermore, although re-intercalation and re-exfoliation were used in this process and first-stage graphite compound was obtained, the resulting graphite platelets are no thinner than 2 nm. Most of the platelets are thicker than 10-15 nm even after further exfoliation and separation via microwave heating (e.g., FIG. 5 of Ref. 10). Re-intercalation by liquid eutectic of sodium and potassium (NaK₂) and subsequent exfoliation yielded platelets with thicknesses of 2-150 nm (Page 976 of Ref. 10). It seems that violent reactions between intercalated alkali metals and water or ethanol tend to result in highly non-uniform exfoliation. It is strange that with alkali metal-intercalated graphite being mostly Stage-1, the resulting platelets exhibit such a wide range of thicknesses (2-150 nm).

By contrast, our invented method consistently produces platelets with an average thickness thinner than 2 nm or 5 layers.

### BRIEF DESCRIPTION OF THE DRAWINGS

FIG. 1 A flow chart showing a two-step or multiple-step process of producing ultra-thin graphite platelets (NGPs with an average thickness thinner than 2 nm or 5 layers).

FIG. 2 Transmission electron micrographs of NGPs: (A) NGP with an average thickness<10 nm; (B) ultra-thin NGPs.

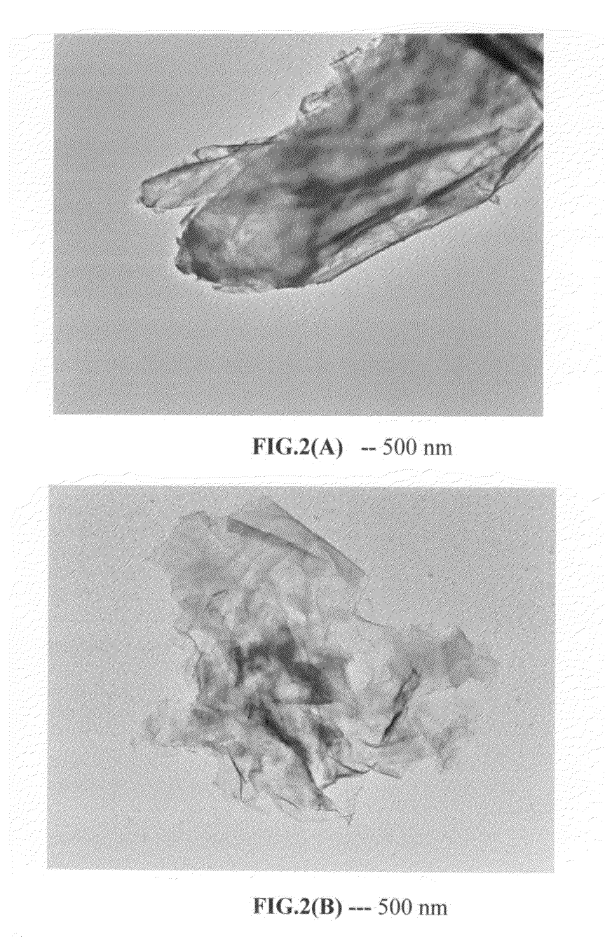

### DETAILED DESCRIPTION OF PREFERRED EMBODIMENTS

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In the case of a carbon or graphite fiber segment, the graphene plates may be a part of a characteristic “turbostratic structure.”

One preferred specific embodiment of the present invention is a method of producing a nano-scaled graphene plate (NGP) material that is essentially composed of a sheet of graphene plane or multiple sheets of graphene plane stacked and bonded together (on average, up to five sheets per plate). Each graphene plane, also referred to as a graphene sheet or basal plane, comprises a two-dimensional hexagonal structure of carbon atoms. Each plate has a length and a width parallel to the graphite plane and a thickness orthogonal to the graphite plane. By definition, the thickness of an NGP is 100 nanometers (nm) or smaller, with a single-sheet NGP being as thin as 0.34 nm. The length and width of a NGP are typically between 1 μm and 20 μm, but could be longer or shorter. For certain applications, both length and width are smaller than 1 μm. In addition to graphite, graphite oxide and graphite fluoride are another two of the many examples of laminar or layered materials that can be exfoliated to become nano-scaled platelets.

Generally speaking, a method has been developed for converting a layered or laminar graphite material to ultra-thin, nano-scaled graphite platelets having an average thickness smaller than 2 nm or 5 layers. The method may be described as having two primary steps: Step (a) and Step (b). Step (a) essentially entails converting a laminar graphite material to NGPs of intermediate thicknesses (preferably, on an average, thinner than 10 nm or 30 layers). In one preferred embodiment of the present invention, Step (b) entails essentially repeating Step (a) to further reduce the average platelet thickness by further exfoliating and separating the already thin platelets to produce ultra-thin NGPs. In another preferred embodiment, Step (b) comprises direct exfoliation and separation of NGPs of intermediate thicknesses to yield ultra-thin NGPs.

After extensive and in-depth studies on the preparation of NGPs, we have surprisingly observed that, if the starting NGPs are of intermediate thicknesses (e.g., thinner than 10 nm or 30 graphene layers), we can readily obtain ultra-thin NGPs via the conventional intercalation/exfoliation route or the new ultrasonication-induced direct exfoliation/separation route. This is regardless if the starting NGPs of intermediate thicknesses are prepared by the conventional intercalation/exfoliation route or the new ultrasonication route. Again, it is important to note that, prior to our invention [Ref. 14], ultrasonication was used to separate exfoliated flakes (after expansion or exfoliation) or to convert flakes to scrolls (after expansion or exfoliation), not for direct exfoliation and separation of flakes.

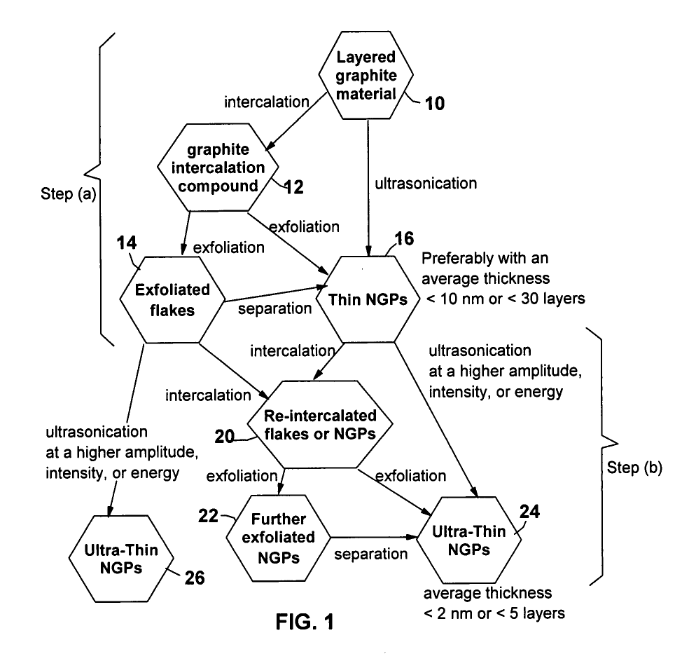

Referring to FIG. 1, Step (a) of preparing a supply of NGPs of intermediate thicknesses can be accomplished in several routes. In one preferred route, Step (a) begins with providing a layered graphite material 10, which is intercalated to produce a graphite intercalation compound (GIC) 12. The GIC can be exfoliated, typically at a high temperature, to produce exfoliated graphite flakes 14, which are then subjected to a separation treatment to yield the desired intermediate-thickness NGPs 16 (on an average, thinner than 10 nm or 30 layers). In some cases, the GIC can be exfoliated to directly become intermediate-thickness NGPs 16 without the additional separation treatment.

The layered graphite material 10 may be selected from natural graphite, synthetic graphite, highly oriented pyrolytic graphite, graphite fiber, graphitic nano-fiber, graphite oxide, graphite fluoride, chemically modified graphite, or a combination thereof. The intercalate may be selected from an acid, an oxidizing agent, a mixture of an acid and an oxidizing agent, a halogen molecule or inter-halogen compound, a metal-halogen compound, an alkali metal, a mixture or eutectic of two alkali metals, an alkali metal-organic solvent mixture, or a combination thereof. More commonly used intercalates are (a) a solution of sulfuric acid or sulfuric-phosphoric acid mixture, and an oxidizing agent such as hydrogen peroxide and nitric acid; and (b) mixtures of sulfuric acid, nitric acid, and manganese permanganate at various proportions. Typical intercalation times are between 1 hour and two days. Exfoliation of the GIC typically occurs via the sudden increase in the inter-laminar gas pressure by exposing the GIC to a temperature higher than the intercalation temperature. The resulting flakes may be subjected to a flake separation treatment using air milling, ball milling, mechanical shearing, ultrasonication, or a combination thereof. The conventional intercalation and exfoliation procedures are described in [Refs. 1-10]. Most recent methods are given in our pending applications [Refs. 11-14].

As illustrated on the right hand side of FIG. 1, an alternative version of Step (a) involves using ultrasonication to directly exfoliate and separate a layered graphite material 10 to produce NGPs 16. The ultrasonication method comprises no intercalation step, although the method is applicable to intercalated graphite or intercalated graphite oxide compounds as well. Using graphite as an example, the first sub-step of Step (a) may involve preparing a laminar material powder containing fine graphite particulates (granules) or flakes, short segments of carbon fiber or graphite fiber, carbon or graphite whiskers, carbon or graphitic nano-fibers, or their mixtures. The length and/or diameter of these graphite particles are preferably less than 0.2 mm (200 μm), further preferably less than 0.01 mm (10 μm). They can be smaller than 1 μm. The graphite particles are known to typically contain micron- and/or nanometer-scaled graphite crystallites with each crystallite being composed of multiple sheets of graphite plane.

The second sub-step of Step (a) comprises dispersing laminar materials (e.g., graphite or graphite oxide particles) in a liquid medium (e.g., water, alcohol, or acetone) to obtain a suspension or slurry with the particles being suspended in the liquid medium. Preferably, a dispersing agent or surfactant is used to help uniformly disperse particles in the liquid medium. Most importantly, we have surprisingly found that the dispersing agent or surfactant facilitates the exfoliation and separation of the laminar material. Under comparable processing conditions, a graphite sample containing a surfactant usually results in much thinner platelets compared to a sample containing no surfactant. It also takes a shorter length of time for a surfactant-containing suspension to achieve a desired platelet dimension. This technique was reported in one of our earlier inventions [Ref. 14].

Surfactants or dispersing agents that can be used include anionic surfactants, non-ionic surfactants, cationic surfactants, amphoteric surfactants, silicone surfactants, fluoro-surfactants, and polymeric surfactants. Particularly useful surfactants for practicing the present invention include DuPont's Zonyl series that entails anionic, cationic, non-ionic, and fluoro-based species. Other useful dispersing agents include sodium hexametaphosphate, sodium lignosulphonate (e.g., marketed under the trade names Vanisperse CB and Marasperse CBOS-4 from Borregaard LignoTech), sodium sulfate, sodium phosphate, and sodium sulfonate.

Although intercalation of graphite is not a requirement for the direct ultrasonication procedure, we have also investigated ultrasonication-induced exfoliation and separation of intercalated compounds at low temperatures (e.g., room temperature). A wide range of intercalates can be used to produce acid-intercalated graphite, which may be subjected to repeated washing and neutralizing steps to produce a laminar compound that is essentially graphite oxide. In other words, graphite oxide can be readily produced from acid intercalation of graphite flakes for a sufficient length of time. The presently invented direct ultrasonication method is applicable to both graphite and graphite oxide that are either un-intercalated or intercalated [Ref. 14].

Step (b) of the presently invented method begins with re-intercalation of the exfoliated graphite flakes 14 or intermediate-thickness NGPs 16 to form re-intercalated flakes or NGPs 20. Some of the flakes in the exfoliated flakes 14 are partially connected with one another (if without the mechanical shearing treatment) and the flakes preferably have an average thickness no greater than 10 nm. In either case of separated NGPs 16 or un-separated flakes 14, the re-intercalated flakes or NGPs 20 can then be subjected to exfoliation to produce further-exfoliated NGPs 22, which are subjected to a mechanical shearing treatment to form the desired ultra-tin NGPs. In some cases, exfoliation of the re-intercalated flakes or NGPs 20 led to the formation of fully separated NGPs even without the mechanical shearing treatment.

The re-intercalation/exfoliation procedure used in Step (b) is fundamentally no different than that in Step (a). The step of intercalating again can comprise using an intercalate selected from an acid, an oxidizing agent, a mixture of an acid and an oxidizing agent, a halogen molecule or inter-halogen compound, a metal-halogen compound, an alkali metal, a mixture or eutectic of two alkali metals, an alkali metal-organic solvent mixture, or a combination thereof. Preferably, alkali metal is not used due to its high sensitivity to moisture in the air. The re-intercalated compound is then exfoliated to produce further-exfoliated NGPs 22 or, directly, ultra-thin NGPs 24 with an average thickness of 2 nm or smaller.

It may be noted that, in a traditional GIC obtained by intercalation of a laminar graphite material (not a re-intercalation), the intercalant species may form a complete or partial layer in an inter-layer space or gallery. If there always exists one graphene layer between two intercalant layers, the resulting graphite is referred to as a Stage-1 GIC. If n graphene layers exist between two intercalant layers, we have a Stage-n GIC. It is generally believed that a necessary condition for the formation of all single-sheet NGPs is to have a perfect Stage-1 GIC for exfoliation. Even with a Stage-1 GIC, not all of the graphene layers get exfoliated for reasons that remain unclear. Similarly, exfoliation of a Stage-n GIC (with n>5) tends to lead to a wide distribution of NGP thicknesses (mostly much greater than n layers). In other words, exfoliation of Stage-5 GICs often yields NGPs much thicker than 10 or 20 layers. Hence, a major challenge is to be able to consistently produce NGPs with well-controlled dimensions from conventional acid-intercalated graphite.

In this context, it is surprising for us to discover that, once the starting NGPs are thinner than 10 nm or 30 layers, re-intercalation tends to lead to mostly Stage-1 and Stage-2 GICs. Subsequent exfoliation tends to produce mostly single-sheet NGPs with some double-sheet NGPs, but with very few NGPs thicker than 5 layers. Thus, one can conclude that re-intercalation/exfoliation is an effective, consistent way of producing ultra-thin NGPs with an average thickness less than 2 nm (or 5 layers), usually less than 1 nm. We have further observed that repeated intercalations and exfoliations can be performed to obtain mostly single-sheet NGPs. For the first time, one can consistently produce single-sheet NGPs for a wide range of industrial uses.

The further-exfoliated product 22 may be subjected to a subsequent mechanical shearing treatment, such as ball milling, air milling, or rotating-blade shearing. With this treatment, multi-layer NGPs are further reduced in thickness, width, and length. In addition to the thickness dimension being nano-scaled, both the length and width of these NGPs could be reduced to smaller than 100 nm in size if so desired. In the thickness direction (or c-axis direction normal to the graphene plane), there may be a small number of graphene planes that are still bonded together through the van der Waal's forces that commonly hold the basal planes together in a natural graphite. Typically, there are less than 5 layers of graphene planes, each with length and width from smaller than 1 μm to 20 μm. High-energy planetary ball mills, air jet mills, and rotating blade shearing devices (e.g., Cowles) were found to be particularly effective in separating nano-scaled graphene plates once exfoliated. Since air jet milling, ball milling, and rotating-blade shearing are considered as mass production processes, the presently invented method is capable of producing large quantities of NGP materials cost-effectively. This is in sharp contrast to the production and purification processes of carbon nano-tubes, which are slow and expensive.

In another preferred embodiment, the nano-scaled platelets 16 of intermediate sizes prepared by either the intercalation/exfoliation route or the direct ultrasonication route, may be subjected to direct ultrasonication, typically at a higher energy level or amplitude than that would be used to produce the platelets of intermediate thicknesses. Such a higher energy level or amplitude serves to further exfoliate the already-thin NGPs 16 prepared in Step (a) to directly produce ultra-thin NGPs 24, as indicated in the lower right portion of FIG. 1. The exfoliated thin flakes 14, with an average flake thickness smaller than 10 nm or 30 layers, can be directly ultrasonicated to produce the ultra-thin NGPs 26, as indicated in the lower left portion of FIG. 1.

Direct ultrasonication has the following major advantages: Conventional exfoliation processes for producing graphite flakes from a graphite material normally include exposing a graphite intercalation compound (GIC) to a high temperature environment, most typically between 850 and 1,050° C. These high temperatures were utilized with the purpose of maximizing the expansion of graphite crystallites along the c-axis direction. Unfortunately, graphite is known to be subject to oxidation at 350° C. or higher, and severe oxidation can occur at a temperature higher than 650° C. even just for a short duration of time. Upon oxidation, graphite would suffer from a dramatic loss in electrical and thermal conductivity. In contrast, the ultrasonication route involves a processing temperature typically lying between 0° C. and 100° C. Hence, this method obviates the need or possibility to expose the layered material to a high-temperature, oxidizing environment.

Ultrasonic or shearing energy also enables the resulting platelets to be well dispersed in the very liquid medium, producing a homogeneous suspension. One major advantage of this approach is that exfoliation, separation, and dispersion are achieved in a single step. A monomer, oligomer, or polymer may be added to this suspension to form a suspension that is a precursor to a nanocomposite structure.

The process may include a further step of converting the suspension to a mat or paper (e.g., using any well-known paper-making process), or converting the nanocomposite precursor suspension to a nanocomposite solid. If the platelets in a suspension comprise graphite oxide platelets, the process may further include a step of partially or totally reducing the graphite oxide after the formation of the suspension. The steps of reduction are illustrated in an example given in this specification.

Alternatively, the resulting platelets, after drying to become a solid powder, may be mixed with a monomer to form a mixture, which can be polymerized to obtain a nanocomposite solid. The platelets can be mixed with a polymer melt to form a mixture that is subsequently solidified to become a nanocomposite solid.

The following examples serve to provide the best modes of practice for the present invention and should not be construed as limiting the scope of the invention:

### Example 1

### Nano-Scaled Graphene Platelets (NGPs) from Highly Oriented Pyrolytic Graphite (HOPG) Flakes via Repeated Halogen Intercalation and Exfoliation Steps

One hundred grams of HOPG flakes, ground to approximately 20 μm or less in sizes, and a proper amount of bromine liquid were sealed in a two-chamber quartz tube with the HOPG chamber controlled at 25° C. and bromine at 20° C. for 36 hours to obtain a halogen-intercalated graphite compound.

Subsequently, approximately ⅔ of the intercalated compound was transferred to a furnace pre-set at a temperature of 200° C. for 30 seconds. The compound was found to induce extremely rapid and high expansions of graphite crystallites with an expansion ratio of greater than 200. The thickness of individual platelets ranged from two graphene sheets to approximately 40 graphene sheets (average of 22 sheets or approximately 7.5 nm) based on SEM and TEM observations.

Approximately one half of these intermediate-thickness NGPs were then sealed in a two-chamber quartz tube with the NGP chamber controlled at 25° C. and bromine at 20° C. for 48 hours to obtain halogen-intercalated NGPs. Subsequently, these re-intercalated NGPs were transferred to a furnace pre-set at a temperature of 200° C. for 30 seconds to produce ultra-thin NGPs. Electron microscopic examinations of selected samples indicate that the majority of the resulting NGPs contain between single graphene sheet and five sheets.

### Example 2

### Ultra-Thin NGPs from Intercalation and Exfoliation of Highly Oriented Pyrolytic Graphite (HOPG) Flakes, Followed by Direct Ultrasonication

Approximately 5 grams of the remaining half of the intermediate-thickness NGPs prepared in Example 1 were dispersed in 1,000 mL of deionized water, along with 0.1% by weight of a dispersing agent (Zonyl® FSO from DuPont), to obtain a suspension. An ultrasonic energy level of 125 W (Branson S450 Ultrasonicator) was used for exfoliation, separation, and size reduction for a period of one hour. Electron microscopic examinations of selected samples indicate that the majority of the resulting NGPs contain between single graphene sheet and seven sheets (average 3-4 sheets).

### Example 3

### NGPs from Natural Graphite Flakes

Five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction for a period of 2 hours. The average thickness of NGPs was approximately 4.5 nm. Approximately half of these intermediate-thickness NGPs were then subjected to ultrasonication under comparable conditions, but at a higher energy level of 125 W, for one hour. The resulting ultra-thin NGPs exhibit an average thickness of approximately 1.4 nm.

### Example 4

### NGPs from Ultrasonication of Natural Graphite Flakes, Followed by Acid Intercalation and Exfoliation

The remaining half of the intermediate-thickness NGPs prepared in Example 3 were intercalated with an acid solution (sulfuric acid, nitric acid, and potassium permanganate at a ratio of 4:1:0.05) for two hours. Upon completion of the reaction, the mixture was poured into deionized water and filtered. The graphite oxide was repeatedly washed in a 5% solution of HCl to remove most of the sulphate ions. The sample was then washed repeatedly with deionized water until the pH of the filtrate was neutral. The slurry was spray-dried and stored in a vacuum oven at 60° C. for 24 hours. The dried powder sample was placed in a quartz tube and inserted into a horizontal tube furnace pre-set at 1,050° C. for 25 seconds. The majority of the resulting NGPs were found to be single-sheet or double-sheet platelets.

### Example 5

### Repeated Interaction, Exfoliation, and Separation Steps of Graphite Oxide

Graphite oxide was prepared by oxidation of graphite flakes with sulfuric acid, nitrate, and permanganate according to the method of Hummers [U.S. Pat. No. 2,798,878, Jul. 9, 1957]. Upon completion of the reaction, the mixture was poured into deionized water and filtered. The sample was then washed repeatedly with deionized water until the pH of the filtrate was approximately 5. The slurry was spray-dried and stored in a vacuum oven at 60° C. for 24 hours. The interlayer spacing of the resulting laminar graphite oxide was determined by the Debey-Scherrer X-ray technique to be approximately 0.73 nm (7.3 Å).

The dried intercalated graphite oxide powder sample was placed in a quartz tube and inserted into a horizontal tube furnace pre-set at 1,050° C. for 25 seconds. The exfoliated worms were mixed with water and were subjected to a mechanical shearing treatment using a Cowels rotating-blade shearing machine for 20 minutes. The resulting flakes (intermediate-thickness platelets) were found to have a thickness of 7.6 nm.

These intermediate-thickness platelets were then re-intercalated with an acid solution (sulfuric acid, nitric acid, and potassium permanganate at a ratio of 4:1:0.05) for two hours. Upon completion of the reaction, the mixture was poured into deionized water and filtered. The graphite oxide was repeatedly washed in a 5% solution of HCl to remove most of the sulphate ions. The sample was then washed repeatedly with deionized water until the pH of the filtrate was neutral. The slurry was spray-dried and stored in a vacuum oven at 60° C. for 24 hours. The dried powder sample was placed in a quartz tube and inserted into a horizontal tube furnace pre-set at 1,050° C. for 25 seconds. The resulting ultra-thin platelets (partially oxidized graphite) have an average thickness of approximately 1.4 nm.

The aforementioned re-intercalation and exfoliation steps were then repeated again. The resulting platelets have an average thickness smaller than 1 nm. Most of the platelets are single layers with some double or triple layers.

### Example 6

### NGP Nanocomposites

Approximately 2 grams of NGPs prepared by spray-drying a portion of the sample prepared in Example 4 was added to 100 mL of water and a 0.2% by weight of a surfactant, sodium dodecylsulfate (SDS), to form a slurry, which was then subjected to ultrasonication at approximately 20° C. for two minutes. A stable dispersion (suspension) of well-dispersed nano-scaled graphite platelets was obtained. A water-soluble polymer, polyethylene glycol (1% by weight), was then added to the suspension. Water was later vaporized, resulting in a nanocomposite containing NGPs dispersed in a polymer matrix.

### Example 7

### NGPs from Short Carbon Fiber Segments

The procedure was similar to that used in Example 5, but the starting material was graphite fibers chopped into segments with 0.2 mm or smaller in length prior to dispersion in water. The diameter of carbon fibers was approximately 12 μm. After repeated intercalation and exfoliation for one time, the platelets exhibit an average thickness of 1.8 nm.

### Example 8

### NGPs from Carbon Nano-Fibers (CNFs)

A powder sample of graphitic nano-fibers was prepared by introducing an ethylene gas through a quartz tube pre-set at a temperature of approximately 800° C. Also contained in the tube was a small amount of nano-scaled Cu—Ni powder supported on a crucible to serve as a catalyst, which promoted the decomposition of the hydrocarbon gas and growth of CNFs. Approximately 2.5 grams of CNFs (diameter of 10 to 80 nm) were subjected to repeated intercalations and exfoliations as in Example 7. Ultra-thin NGPs with an average thickness of 1.5 nm were obtained.

### Example 9

### Graphite Oxide Nano Platelets, Their Nanocomposites, and Their Reduced Versions

Approximately 2 grams of NGPs prepared by spray-drying a portion of the sample prepared in Example 4 was added to 100 mL of water and a 0.2% by weight of a surfactant, sodium dodecylsulfate (SDS), to form a slurry, which was then subjected to ultrasonication at approximately 20° C. for two minutes. A stable dispersion (suspension) of well-dispersed nano-scaled graphite platelets was obtained.

A small amount of the nano platelet-water suspension was reduced with hydrazine hydrate at 100° C. for 24 hours. As the reduction process progressed, the brown-colored suspension of graphite oxides turned black, which appeared to become essentially graphite nano platelets or NGPs.

Another attempt was made to carry out the reduction of the graphite oxide nano platelets prepared via the presently invented method. In this case, hydrazine hydrate reduction was conducted in the presence of poly (sodium 4-styrene sulfonate) (PSS with Mw=70,000 g/mole). A stable dispersion was obtained, which led to PSS-coated NGPs upon removal of water. This is another way of producing platelet-based nanocomposites.

1. A method of producing ultra-thin, separated nano-scaled platelets having an average thickness no greater than 2 nm or comprising, on an average, no more than 5 layers per platelet from a layered graphite material, said method comprising:
a) providing a supply of nano-scaled platelets or exfoliated flakes with an average platelet or flake thickness of no more than 10 nm or, on an average, having no more than 30 layers per platelet or flake; and
b) intercalating said supply of nano-scaled platelets or exfoliated flakes to produce intercalated nano platelets or flakes and exfoliating said intercalated nano platelets or flakes at a temperature and a pressure for a sufficient period of time to produce said ultra-thin nano-scaled platelets.

2. The method of claim 1 wherein said supply of nano-scaled platelets or exfoliated flakes is obtained through intercalation and exfoliation of said layered graphite material selected from natural graphite, synthetic graphite, highly oriented pyrolytic graphite, graphite fiber, graphitic nano-fiber, graphite oxide, graphite fluoride, chemically modified graphite, or a combination thereof.

3. The method of claim 1 wherein said supply of nano-scaled platelets is obtained through ultrasonication of said layered graphite material.

4. The method of claim 1 wherein said supply of nano-scaled platelets is obtained through intercalation and exfoliation of said layered graphite material to produce exfoliated graphite flakes, which are then subjected to flake separation treatment using air milling, ball milling, mechanical shearing, ultrasonication, or a combination thereof.

5. The method of claim 1 wherein said step (b) of intercalating said supply of nano-scaled platelets or exfoliated flakes comprises using an intercalate selected from an acid, an oxidizing agent, a mixture of an acid and an oxidizing agent, a halogen molecule or inter-halogen compound, a metal-halogen compound, an alkali metal, a mixture or eutectic of two alkali metals, an alkali metal-organic solvent mixture, or a combination thereof.

6. The method of claim 1 wherein said intercalated nano platelets or exfoliated flakes comprise first-stage intercalation compound.

7. The method of claim 1 wherein said intercalated nano platelets or exfoliated flakes comprise first-stage, second-stage, third-stage, fourth-stage, or fifth-stage intercalation compound.

8. The method of claim 1 wherein said step (b) of intercalating and exfoliating is followed by a mechanical separation or size reduction treatment using air milling, ball milling, mechanical shearing, ultrasonication, or a combination thereof.

9. The method of claim 1 wherein said platelets comprise graphite oxide platelets and said method further includes a step of partially or totally reducing said graphite oxide.

10. The method of claim 1 wherein said platelets comprise single-layer graphene platelets.

11. A method of producing ultra-thin, separated nano-scaled platelets having an average thickness no greater than 2 nm or comprising, on an average, no more than 5 layers per platelet from a layered graphite material, said method comprising:
a) providing a supply of nano-scaled platelets or exfoliated flakes with an average thickness of no more than 10 nm or, on an average, having no more than 30 layers per platelet or flake; and
b) dispersing said supply of nano-scaled platelets or flakes in a liquid medium containing therein a surfactant or dispersing agent to produce a suspension or slurry; and
c) exposing said suspension or slurry to ultrasonication at a sufficient energy level for a sufficient length of time to produce said ultra-thin, separated nano-scaled platelets.

12. The method of claim 11 wherein said ultrasonication step is conducted at a temperature no greater than 100° C.

13. The method of claim 11 wherein said energy level is greater than 150 watts.

14. The method of claim 11 wherein said ultrasonication step is followed by a mechanical shearing treatment selected from air milling, ball milling, rotating blade shearing, or a combination thereof.

15. The method of claim 11 wherein said liquid medium comprises water, organic solvent, alcohol, a monomer, an oligomer, or a resin.

16. The method of claim 11 wherein said platelets comprise single-layer graphene platelets.

17. The method of claim 11 wherein said surfactant or dispersing agent is selected from the group consisting of anionic surfactants, nonionic surfactants, cationic surfactants, amphoteric surfactants, silicone surfactants, fluoro-surfactants, polymeric surfactants, sodium hexametaphosphate, sodium lignosulphonate, poly (sodium 4-styrene sulfonate), sodium dodecylsulfate, sodium sulfate, sodium phosphate, sodium sulfonate, and combinations thereof.

18. The method of claim 11 wherein said layered graphite material comprises natural graphite, synthetic graphite, highly oriented pyrolytic graphite, graphite oxide, graphite intercalated with a non-halogen intercalate, graphite fiber, graphitic nano-fiber, or a combination thereof.

19. The method of claim 11 wherein said liquid medium contains a monomer or a polymer dissolved or dispersed therein to form a nanocomposite precursor suspension.

20. The method of claim 19 further including a step of converting said suspension to a mat or paper, or converting said nanocomposite precursor suspension to a nanocomposite solid.

21. The method of claim 20 wherein said platelets comprise graphite oxide platelets and said method further includes a step of partially or totally reducing said graphite oxide after the formation of said suspension.

22. The method of claim 11 wherein no surfactant or dispersing agent is used.

23. The method of claim 11 wherein said step (a) of providing a supply of nano-scaled platelets comprising subjecting said layered graphite material to ultrasonication at a first amplitude or first energy level and said step (c) comprises ultrasonication at a second amplitude greater than the first amplitude, or at a second energy level, which is greater than the first energy level.

24. A method of producing ultra-thin, separated nano-scaled platelets having an average thickness no greater than 2 nm or comprising, on an average, no more than 5 layers per platelet from a layered graphite material, said method comprising:
a) intercalating said layered graphite material to form an intercalated graphite compound and exfoliating said intercalated graphite compound to produce an exfoliated graphite material;
b) re-intercalating said exfoliated graphite material with a non-alkali metal-based intercalant to form a further intercalated graphite compound and exfoliating said further intercalated graphite compound at a temperature and a pressure for a sufficient period of time to produce said ultra-thin nano-scaled platelets.

25. The method of claim 24, comprising additional re-intercalating and exfoliating steps.
